(19) United States
(12) Patent Application Publication
(10) Pub. No.: US 2026/0030544 A1
(43) Pub. Date: Jan. 29, 2026

(54) META-LEARNING FOR EFFICIENT AND ROBUST TRAINING OVER SYNTHETIC DATA

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR); Pablo Nascimento da Silva, Niterói (BR)

(21) Appl. No.: 18/784,342

(22) Filed: Jul. 25, 2024

(51) Int. Cl. G06N 20/00

(52) U.S. Cl. CPC G06N 20/00

(57) ABSTRACT

Training a machine learning model using augmented synthetic data. A synthetic dataset is generated and augmented with various augmentation functions to generate an augmented dataset. A training round is performed and augmentation metrics for each of the augmentation functions that have been applied. Using the augmentation metrics, the augmentation metric that most impacts the worst performing augmentation metric is selected. The selected augmentation function is used to select data for training the model in the next training round. This may continue until the model is sufficiently trained.

### TECHNOLOGICAL FIELD OF THE DISCLOSURE

Embodiments disclosed herein generally relate to machine learning, machine learning models, and to training machine learning models. More particularly, at least some embodiments relate to systems, hardware, software, computer-readable media, and methods for training machine learning models using synthetic data, generating the synthetic data, and synthetic based meta-learning during training/learning operations.

### BACKGROUND

Machine learning models can provide significant benefits. However, developing, preparing and training machine learning models can be challenging from multiple perspectives. For example, many collaborations and partnerships (e.g., with customers) in the machine learning space involves some form of on-premise model training. Large amounts of high-quality data are beneficial from a training perspective. However, obtaining high-quality labeled data is very costly and can impede model deployment at scale at least because human involvement is often required to label the data.

There is a growing amount of data available, both in data centers and generated at the edge. Due to the magnitude of these databases (zettabytes of data is likely in the near future), automatic intervention (data management) is increasingly necessary for sorting, classifying and checking these data.

Data management includes document management. Automatic interventions, such as translation, transcription, classification and comprehension, may be attempted using digital transformation techniques and machine learning. In addition to these interventions, privacy and security are important aspects of document management. There is a growing need to ensure that customer data is properly handled and stored.

Automatic document management may improve the security and privacy of customer data. Automatic document management may also ensure that customer data is handled ethically and in accordance with regulatory requirements.

Classic approaches to automatic document processing involve the use of optical character recognition (OCR) such as tesseract. Although OCR techniques have had some success and may return position information in addition to text, documents that include noise or clutter are more challenging to process using OCR. Further, OCR techniques do not provide semantic information.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1A discloses aspects of training a machine learning model;

FIG. 1B discloses aspects of meta-learning in the context of training a machine learning model;

FIG. 1C discloses additional aspects of meta-learning in the context of training a model;

FIG. 2A discloses aspects of generating synthetic data and/or augmented data using one or more augmentation functions;

FIG. 2B discloses aspects of augmentation functions or generative factors for data augmentation;

FIG. 3A discloses aspects of determining and aggregating augmentation metrics;

FIG. 3B discloses aspects of evaluating the aggregated metrics;

FIG. 3C discloses aspects of determining the pseudo gradients;

FIG. 3D discloses aspects of a heap structure in the context of selecting an augmentation function for a training round;

FIG. 3E discloses aspects of selecting the augmentation function that affects the worst performing augmentation function;

FIG. 3F discloses aspects of selecting the augmentation function that affects the worst performing augmentation function for a next or subsequent training round;

FIG. 4 discloses aspects of a method for training a machine learning model; and

FIG. 5 discloses aspects of a computing device, system, or entity.

### DETAILED DESCRIPTION OF SOME EXAMPLE EMBODIMENTS

Embodiments disclosed herein generally relate to machine learning. More particularly, at least some embodiments relate to systems, hardware, software, computer-readable media, and methods for meta-learning in machine learning models and to training machine learning models over synthetic data.

Embodiments of the invention more specifically relate to training machine learning models with data that may include synthetic data. The synthetic data, before and/or during training or learning operations, may be adapted or augmented. Training with augmented synthetic data ensures that training is more comprehensive, balanced, and distributed.

Meta-learning refers, by way of example, to methods for improving machine model learning. Meta-learning may refer to the manner in which data is augmented (e.g., selected, adapted, changed) during machine learning training operations. Meta-learning, in one embodiment, is performed in the context of synthetic data generation and generative factors for augmenting the synthetic data.

Data augmentation refers, by way of example, to transforming (adapting, changing, altering) synthetic data to create variability and increase the reach of the training distribution. Example data augmentations include, but are not limited to, adding gaussian noise to the synthetic data, rotating the synthetic data, generating random text to include in the synthetic data, or the like or combinations thereof.

Machine learning can be applied to a variety of domains. Embodiments of the invention are discussed in the context of extracting data from documents or images of documents. Embodiments of the invention, however, are not limited to data extraction and May be applied to other domains.

Embodiments of the invention relate more specifically to training or learning operations that include meta-learning, data augmentation, and/or data augmentation function selection. Selecting specific data augmentation functions can prevent training imbalance. Stated differently, detecting imbalance in machine model learning can be resolved such that training is more efficient and reduces or prevents the need for model re-training.

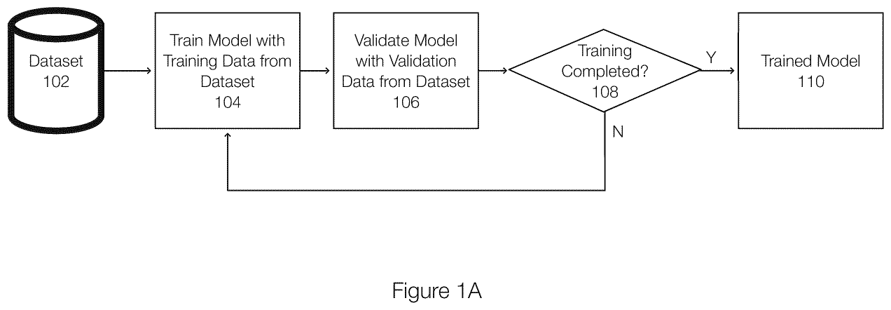

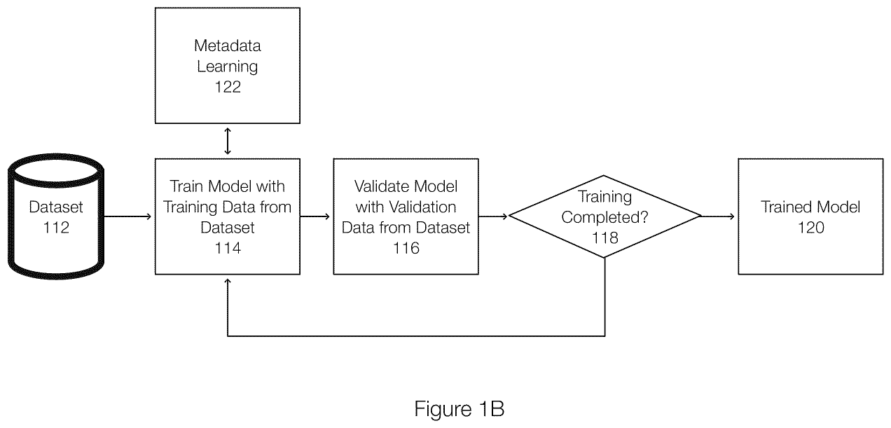

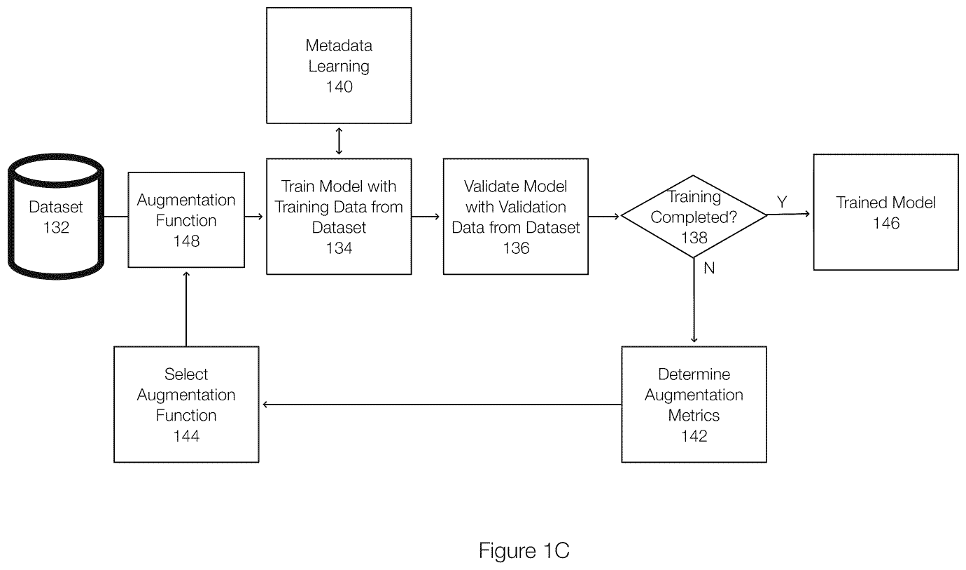

FIG. 1A discloses aspects of training a machine learning model. In FIG. 1A, a dataset 102 is obtained or created. The dataset 102 may include real data and/or synthetic data. Training data from the dataset 102 is input to a model during a training operation. The model is validated 106 with validation data included in the dataset 102. Embodiments of the invention may include a validation loop during each training round. If model training is completed (Y at 108), the trained model 110 is ready for deployment. If training is not completed (N at 108), another round of training and/or validation may be performed using training data from the dataset 102.

FIG. 1B discloses aspects of meta-learning in the context of training a machine learning model. In this example, the dataset 112 (an example of the dataset 102) may include training data and validation data. The model is trained 114 using the training data from the dataset 112 and validated 116 with the validation data from the dataset 112 during each of the training rounds. When training 114 the model, meta-learning 122 may be performed to adapt the model. In one embodiments, the meta-learning is performed in the context of synthetic data or a synthetic generation framework such that the machine model learning can be adapted during training. If training is completed (Y at 118), the trained model 120 is obtained. If training is not completed (N at 118), another training round and metadata learning 122 may be performed.

FIG. 1C discloses additional aspects of meta-learning in the context of training a model. The meta-learning includes augmenting the synthetic data. In FIG. 1C, the dataset 132 is an augmented dataset. In this example, an augmentation function 148 may be applied to the dataset 132 (or portion thereof) during the training round and/or prior to the training operation.

The model 146 is trained 134 using the augmented training dataset, metadata learning 140 is performed, the model is validated 136 with validation data from the dataset 132. If training is completed (Y at 138), the trained model 146 is obtained. If training is not completed (N at 138), augmentation metrics 142 are obtained and at least one augmentation function is selected 144 for use during the next training round. More specifically, training data associated with the selected augmentation function is used during the next training round.

As previously stated, embodiments of the invention are discussed in the context of document management, which includes data extraction from images of documents. In this type of domain, it is possible to generate valid synthetic data from a given datum using available generative factors for data augmentation. If a document template is available and the generative factors (augmentation functions) are defined, synthetic data can be generated. Using a document template, multiple synthetic documents can be generated using the template. Augmentation functions can be applied to the resulting synthetic data to generate augmented synthetic data.

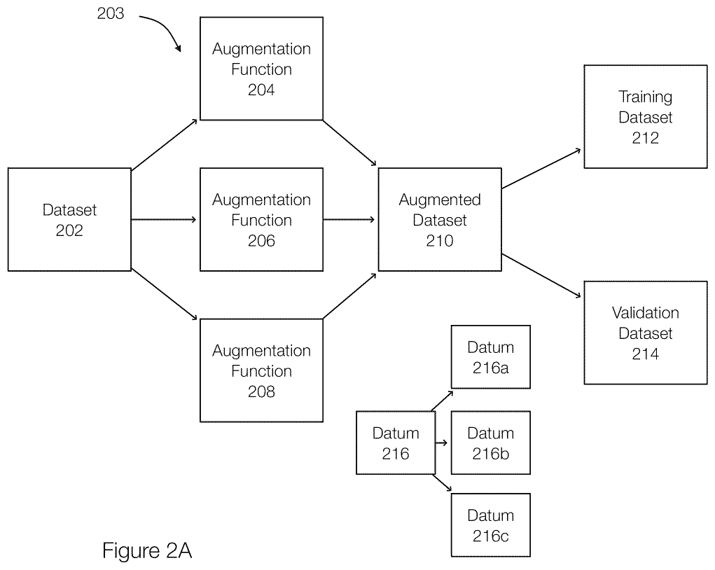

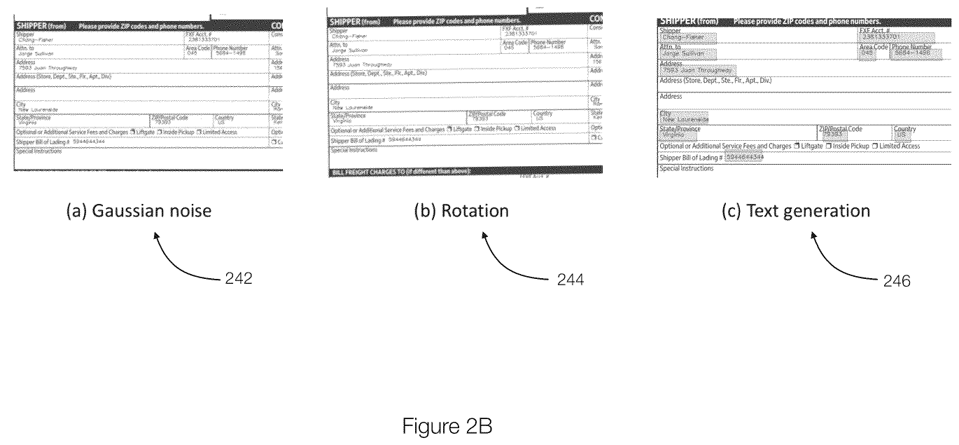

FIG. 2A discloses aspects of generating synthetic data and/or augmented synthetic data using one or more augmentation functions. An augmentation function, by way of example only, is a parameterized function that augments a given datum. Augmentation functions 203 are represented as augmentation functions 204, 206, and 208. In one example, the augmentation function 204 may add Gaussian noise to a datum. The augmentation function 206 may rotate a datum by a particular amount. The augmentation function 208 may generate random text to include in a datum. Other augmentation functions may include, by way of example only, changing the font type, the font size, font position, font rotation, or the like or combinations thereof.

Once the augmentation functions 203 have been applied to the dataset 202, an augmented dataset 210 is generated. The augmented dataset 210 may be divided into a training dataset 212 and a validation dataset 214.

In this example, the augmentation functions 203 may be applied separately to each datum. This may generate multiple augmented instances of a datum. Thus, a datum 216 (which may be a synthetic datum) is used to generate datums 216a, 216b, and 216c, each of which corresponds to a different augmentation function 204, 206, or 208. In another example, multiple augmentation functions may be applied together.

Generating synthetic data in this manner allows augmentation metrics to be tracked on a per datum and/or per augmentation function basis. Stated differently, the augmentation functions applied to each datum are tracked in one example.

Because each augmentation function changes or adapts the datum, each augmentation function may influence the training operation in a different manner. In other words, the learning may be impacted by each of the augmentation functions. For instance, the application of one augmentation function 204 may correlate proportionately or inversely with the augmentation functions 206 and/or 208. Embodiments of the invention evaluate the impact or effect of the augmentation functions on the training operation or on the model being trained. The impact may be determined, in one example, using augmentation metrics.

The augmentation metrics may be used to select the augmentation function or set of augmentations functions used during a next training round. Once an augmentation function is selected, datums augmented with the selected augmentation function or set of augmentation functions may be used for training during the next training round.

In one example, augmentation metrics are generated or determined such that the influence of different augmentation functions on the training operation can be correlated or determined. In one example, the augmentation metrics to determine or measure may be defined by a domain expert.

The augmentation metrics may be determined using the validation dataset. A validation loop is performed in each training round or epoch in order to determine the augmentation metrics. Augmentation metrics may be determined after each training round.

In one example, the augmentation metrics include a validation error. Other metrics that are relevant to the domain may also be determined or considered. For example, with regard to automatic document processing, character error (e.g., Levenshtein distance) may be employed. By way of example, the augmentation metrics are configures such that a higher metric conveys a worse or poorer performance. However, the augmentation metrics can be configured in different manners.

These individual metrics can be combined into a single augmentation metric by aggregating the individual metrics in some manner. For example, all metrics may be normalized and added together. In addition, augmentation metrics for each of the augmentation functions may also be determined. Because the augmentation functions applied to a datum are tracked in one example, augmentation metrics per augmentation function can be determined.

FIG. 2B discloses aspects of augmentation functions or generative factors for data augmentation. FIG. 2B illustrates a gaussian noise augmentation function 242, a rotation augmentation function 244, and a text generation augmentation function 246. In this example, each datum is an image of a document that may include text and the model may be configured to extract the text from the image. The model 242 may add noise (e.g., blur the image) the model 244 may rotate the image such that the orientation of the text is different, and the model 246 may generate text to include in the datum.

More specifically, these augmentation functions 242, 244, 246 can be parameterized with one or more parameters. They can be straightforward functions, such as applying Gaussian noise to the document image, or rotation by a given amount. They can also be more complex, such as generating random, but semantically valid content for different fields. An augmentation function such as the one for text generation may include a machine learning model itself (e.g., a language model to generate content).

The extent to which simple or more complex augmentation functions are used may depend on the computational infrastructure available to perform training and validation operations. The augmentation functions selected may also depend on the domain expert evaluation.

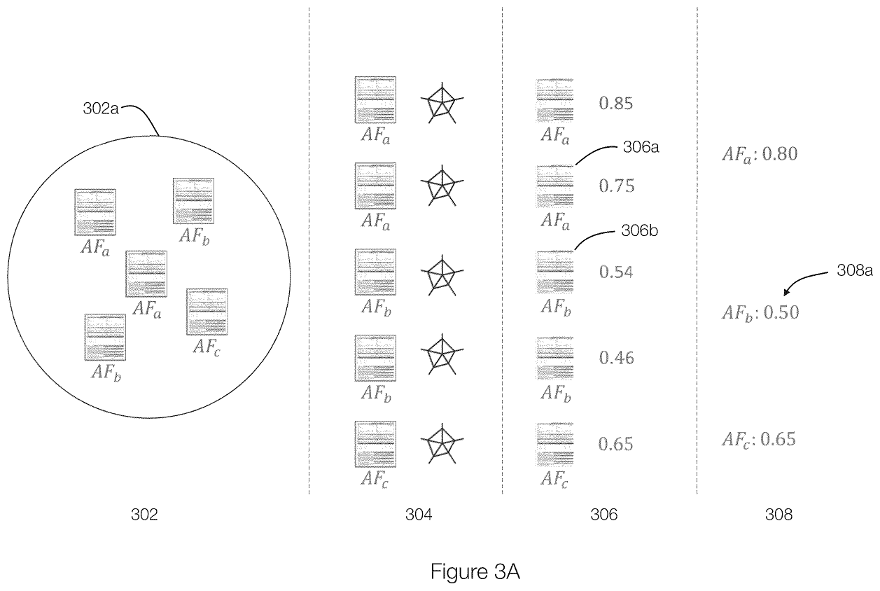

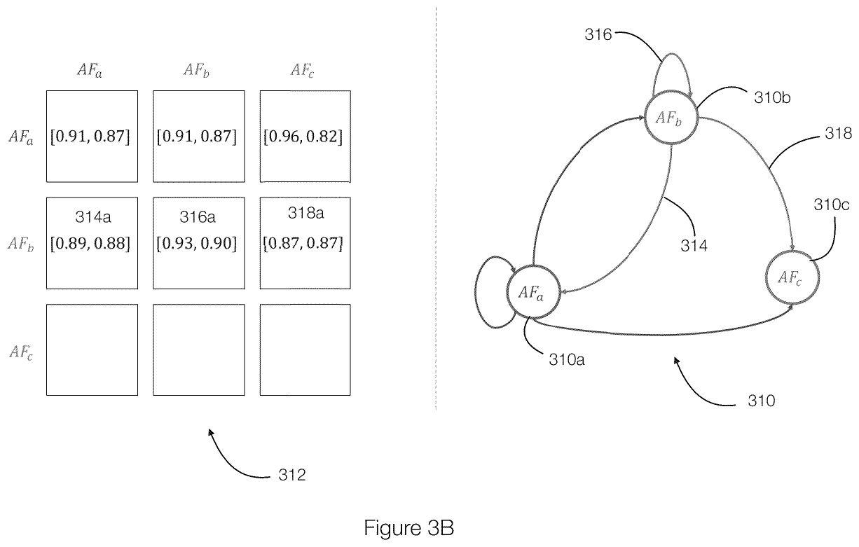

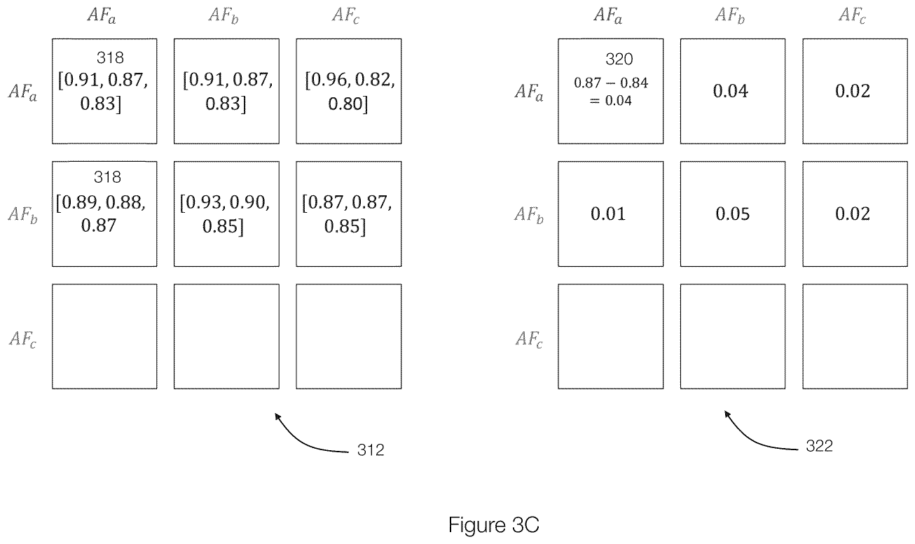

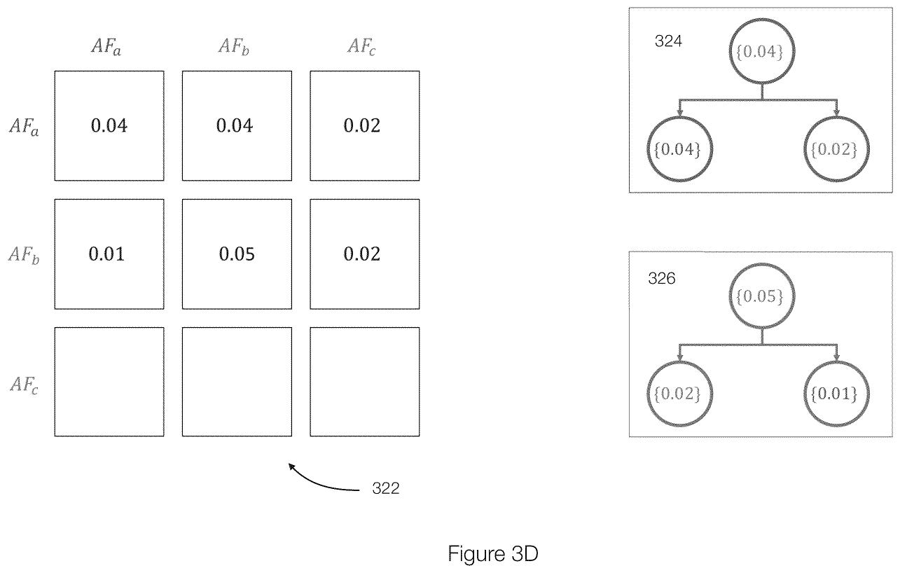

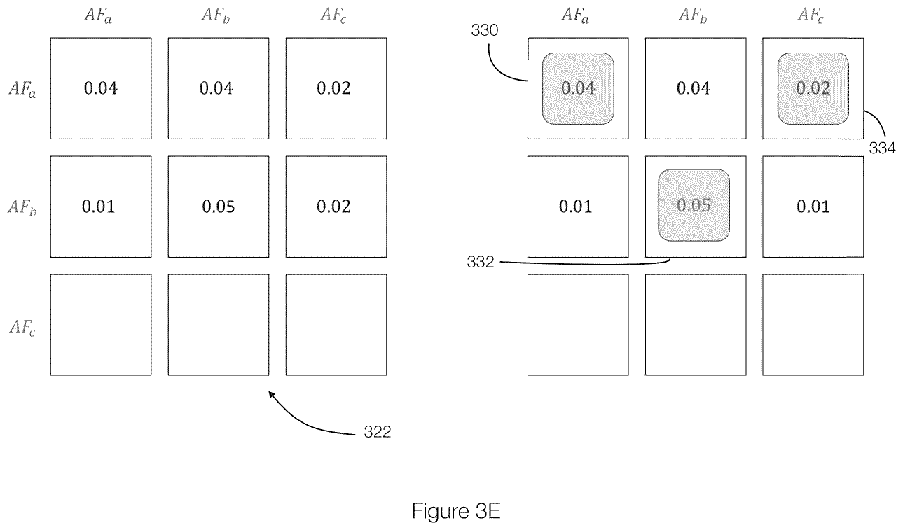

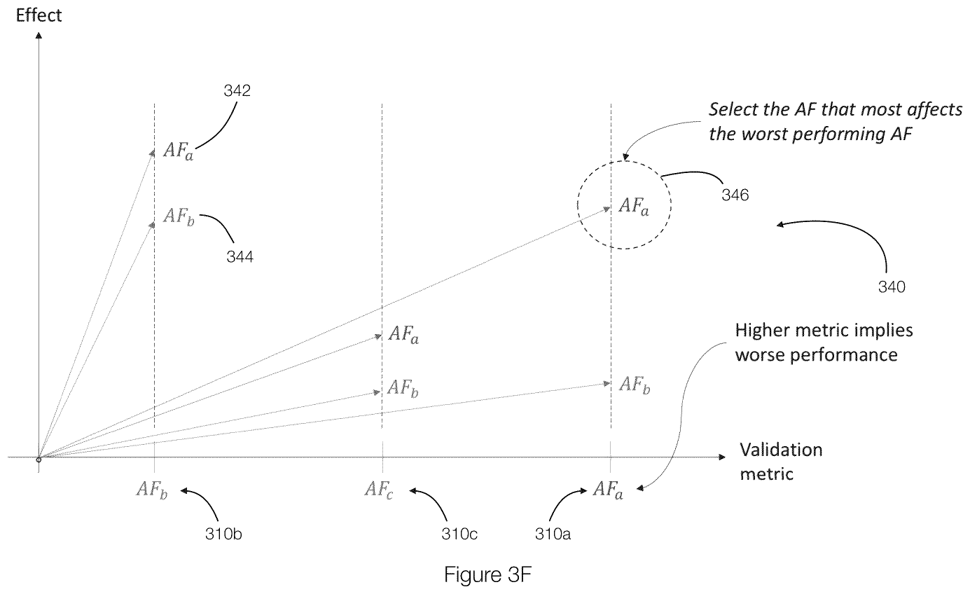

FIG. 3A discloses aspects of determining and aggregating augmentation metrics. For discussion purposes, this process is illustrated in stages. At the stage 302, a validation dataset 302a used during a validation operation is illustrated. Each of the datums is associated with an augmentation function, which is tracked on a per datum basis. At the stage 304, multiple augmentation metrics are collected for each individual datum. The augmentation metrics may be determined from an output of the model and labels of the validation dataset. At the stage 306, augmentation metrics are aggregated on a per datum basis. For example, the datums 306a and 306b are both associated with a particular augmentation function AF_{b} (e.g., augmentation function 206). As illustrated, the datum 306a is associated with an aggregated metric of 0.54 and the datum 306b is associated with an aggregated metric of 0.46. More specifically, the datum 306a may be associated with a loss error and with a character error. These errors may be combined to generate or determine the aggregated metric of 0.54 for the datum 306a.

The stage 308 illustrates augmentation metrics per augmentation function. Thus, all augmentations metrics of datums to which the augmentation function AF_{b} has been applied are aggregated into an aggregated metric 308a of 0.50. In this example, the aggregated metric 308 for the augmentation function is an average of the aggregated metrics illustrated at stage 306. For example, the metric 308a for the augmentation function AF_{b} is generated from the datum specific aggregated metrics of the datums 306a and 306b (e.g., 0.50 is an average of 0.54 and 0.46).

FIG. 3B discloses aspects of evaluating the aggregated metrics. In one example, determining the aggregation metrics for an augmentation function may be evaluated using graphs.

Because no augmentation metrics are available the first training operation or training round is performed, the augmentation function to be applied or used during the training round may be selected at random or in another manner. Once the initial augmentation function is determined or selected, a training loop is performed and augmentation metrics can be determined. During subsequent training rounds, the augmentation function to use is selected based on the aggregation metrics. More specifically, the training data to use during the next training round includes data that was augmented by the selected augmentation function.

In one example, a graph-heap structure or directed graph 310 may be used. In this example, the nodes 310a, 310b, and 310c (respectively functions AFₐ, AF_{b}, AF_{c}) represent or correspond to the augmentation functions (e.g., functions 204, 206, and 208). The nodes 310a, 310b, and 310c are referred as functions or nodes or depending on context for ease of explanation. The edges of the graph 310 point from an applied augmentation function to an affected augmentation function after a training loop. If an augmentation function has not been applied, no edges come out from the corresponding node of the graph 310.

In this example, one or more training rounds have been applied. The graph 310 illustrates that the augmentation functions 310a AFₐ and 310b AF_{b} have been applied while the augmentation function AF_{c} has not been applied. More specifically, the row represents the function being applied. In this example, no edges leave the node 310c and the corresponding row in the table 312 is empty. Edges leaving the nodes 310a and 310b represent the augmentation metrics illustrated in the table 312.

More specifically, the graph 310 illustrates that the training rounds have used data to which the functions 310a and 310b have been applied.

The edges are explained with respect to the node 310b. In this example, the edge 314 represents that the function 310b was applied and represents the impact of the function 310b on the function 310a. The corresponding metrics 314a in the table 312 is a list illustrating the impact of the function 310b on the function 310a. The edge 316 (a self-edge) is associated with metrics 316a and represents the impact of the function 316 on itself. The edge 318 represent the impact of the applied function 310b on the function 310c and is associated with aggregation metrics 318a.

The table 312 does not include any metrics for the function 310c because the function has not been applied during the training operations. The table 312 stores aggregation metrics representing the impact or influence of each aggregation function on the other aggregation functions.

In this example, the metrics 314a is a list that includes values of 0.89 and 0.88. These values each correspond to aggregated metrics of an augmentation function for a training round. Thus, the value of 0.89 may correspond to augmentation metrics for a training round n and the value of 0.88 corresponds to augmentation metrics for a training round n+1.

FIG. 3C discloses aspects of determining pseudo gradients. The aggregation metrics illustrated in the table 312 are evaluated to determine the pseudo gradients illustrated in the table 322. For example, at this point of the training operation, the metrics 318 include a list of metrics including values 0.91, 0.87, and 0.83. The pseudo gradient is determined, by way of example only, by subtracting the penultimate entry from the last entry. Thus, the pseudo gradient 320 for the metrics 318 is 0.04. The pseudo gradient 320 represents the impact of the function AFₐ (function 310a) on itself. Thus, the pseudo gradients in the table 322 are all determined in a similar manner and represent the impact of an applied function on other functions. A list of pseudo gradients may be generated if necessary.

FIG. 3D discloses aspects of a heap in the context of selecting an augmentation function for a training round. FIG. 3D illustrates the pseudo gradients in the table 322 and illustrates the same data in heap structures 324 and 326. Thus, the heap 324 corresponds to the node or function 310a (AFₐ) and the heap 326 corresponds to the node or function 310b (AF_{b}). In other words, the heap 324 represents the impact of the function 310a (AFₐ) on other functions (including itself). The heap 326 similarly represents the impact of the function 310b (AF_{b}).

FIG. 3E discloses aspects of selecting the augmentation function that most affects the worst performing augmentation function. More specifically, the aggregation metrics are used to identify the augmentation function to be used in the next training round. Once the augmentation function is identified, corresponding data is selected and used for training.

In this example, the table 322, which stores or includes the pseudo gradients, is used to determine, for each augmentation function, which augmentation function has the largest impact. In this example, the augmentation function that impacts the augmentation function AFₐ the most is itself as illustrated by the metric 330. The augmentation function that impacts the augmentation function AF_{b} the most is itself as illustrated by the metric 332. The augmentation function that impacts the augmentation AF_{c} the most is the augmentation function AFₐ as illustrated by the metric 334.

FIG. 3F discloses aspects of selecting the augmentation function that affects the worst performing augmentation function the most for a next or subsequent training round. Using the heap (or other structure), a graph 340 or other representation may be generated. The vertical axis represents the effect (e.g., the pseudo gradient) of a function. Using the table 322, by way of example, the effects or pseudo gradients (342 and 344) are plotted with respect to the function 310b.

In this example, the worst performing augmentation function is the function 310a (AFₐ). The augmentation function that most affected the worst performing augmentation function is itself (illustrated at 346). Thus, the next training round will apply the augmentation function 310a (or data to which the function 310a has been applied) for the next training round.

In the foregoing example, the augmentation function 310c (AF_{c}) has not been applied. In one example, embodiments of the invention may select the most impactful augmentation function and/or select an augmentation function that has not yet been applied. In one example, the choice may be a parameter that may be determined by a domain expert. In another example, embodiments of the invention may alternate between choosing the most impactful augmentation function or an augmentation function that has not been applied.

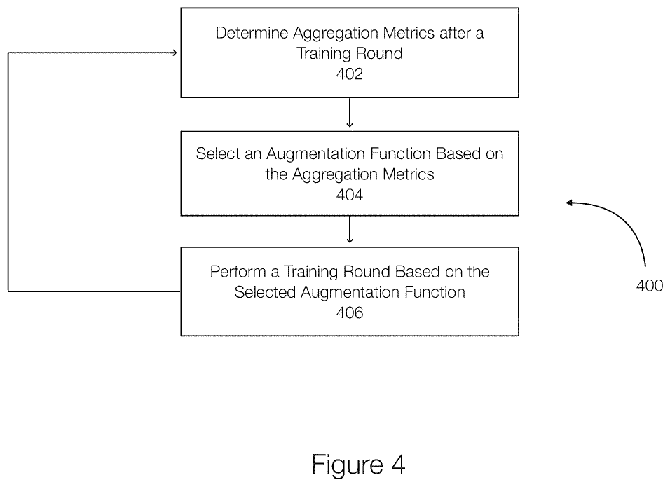

FIG. 4 discloses aspects of a method for training a machine learning model. The method 400 includes determining 402 aggregation metrics after a training round. Determining the aggregation metrics may further include determining pseudo gradients. Various structures, such as heaps or graphs, may be generated as necessary.

Next, an augmentation function is selected 404 based on the aggregation metrics. In one example, the function that has the greatest impact on the worst performing augmentation function (or a previously unapplied augmentation function) is selected for the next training round. Next, a training round is performed 406 based on the selected augmentation function. The training process then repeats if necessary. The subsequent training round generates new augmentation metrics that can be used to select the next augmentation function to be applied. This produces a trained model that is better equipped and trained to perform its learned function because the data used during training is augmented.

As previously stated, a model may be trained in the domain of extracting data or information from documents (or document images). For example, an entity may desire to extract information from scanned purchase orders. The extracted data can be structured and stored. Extracting the data allows the information to be searched, checked, or used for other purposes.

Even if a dataset of purchase orders may be available, the data may be unlabeled and require annotation. Thus, a synthetic database is generated synthetically. This removes the cost of annotating the data and allows large datasets to be generated on demand.

The generation of synthetic data usually requires the definition of a set of augmentation procedures that transform synthetic data to create variability and increase the training distribution's reach. Embodiments of the invention ensure that imbalances can be avoided during the training operation. For example, the model may be overfitted to one of the augmentations. Conventionally, the solution is complete training and then check for discrepancies during validation. Embodiments of the invention perform a form of meta-learning inside a synthetic data generation framework such that training operation can be adapted during training. Embodiments of the invention thus use, in one example, a graph gradient augmentation selection method to select an augmentation function for each training round.

As previously stated, embodiments of the invention are described in the context of extracting data from documents or automatic document processing. In addition to improving compliance with regulatory and ethical issues, automatic document processing may be able to increase the productivity of people in bureaucratic processes. For example, processing purchase orders may involve many different steps. A person first opens the document, understands the document, identifies and extracts fields of interest, fill out forms with data from the document for further processing, and the like. Automating these processes would greatly improve productivity.

The ability to automatically classify and extract data from documents would decrease the time spent on repetitive tasks, thereby increasing productivity. Automating these processes may also lead to standardization, which would increase confidence in these automated processes.

Automated document processing faces, unfortunately, many different challenges that include variation in document standards, complex and varied layouts, different fonts (e.g., scanned, printed, handwritten), and the like.

Many entities process large numbers of documents of various kinds (e.g., purchase orders, receipts, reports) and the ability to automatically classify and extract these documents would be beneficial from at least a productivity perspective. Automated document processing could be applied to a variety of activities including screening, classification, mining, categorization, summarizing, comprehension, translation, and the like.

Embodiments of the invention address these issues by augmenting the data such that documents of various kinds can be better classified and such that data can be extracted more efficiently.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, machine learning related operations, training operations, data augmentation operations, meta learning operations, augmentation selection operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment. In addition to the cloud environment, the operating environment may also include one or more clients that are capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for method for training a machine learning model, the method comprising: determining aggregation metrics for each of a plurality of augmentation functions after performing a current training round of a training operation, selecting an augmentation function from among the plurality of augmentation functions for a next training round that most impacts a worst performing augmentation function in the training operation, and performing a next training round using training data from an augmented dataset, wherein the training data is associated with the selected augmentation function.

Embodiment 2. The method of embodiment 1, wherein determining the aggregation metrics comprises determining an individual aggregation metric for each datum used in the current training round.

Embodiment 3. The method of embodiment 1 and/or 2, wherein the individual aggregation metric is an aggregation of one or more metrics determined for the current training round.

Embodiment 4. The method of embodiment 1, 2, and/or 3, wherein the one or more metrics include a validation loss and/or a character error.

Embodiment 5. The method of embodiment 1, 2, 3, and/or 4, further comprising determining a function aggregation metric for each of the plurality of augmentation functions using the individual aggregation metrics.

Embodiment 6. The method of embodiment 1, 2, 3, 4, and/or 5, further comprising determining a pseudo gradient for each of the plurality of functions, wherein each of the pseudo gradients reflects an impact of an applied augmentation function on each of the other augmentation functions including the applied aggregation function.

Embodiment 7. The method of embodiment 1, 2, 3, 4, 5, and/or 6, further comprising generating a synthetic dataset applying one or more augmentation functions to generate an augmented dataset, wherein each augmented datum is tracked according to the applied augmentation function.

Embodiment 8. The method of embodiment 1, 2, 3, 4, 5, 6, and/or 7, further comprising applying the one or more augmentation functions to each datum in the dataset to generate an augmented dataset, wherein the augmented dataset includes a training dataset and a validation dataset.

Embodiment 9. The method of embodiment 1, 2, 3, 4, 5, 6, 7, and/or 8, wherein the one or more augmentation functions include a gaussian noise augmentation function, an image rotation augmentation function, and a text generation augmentation function.

Embodiment 10. The method of embodiment 1, 2, 3, 4, 5, 6, 7, 8, and/or 9, wherein the selected augmentation function comprises a previously unapplied augmentation function.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

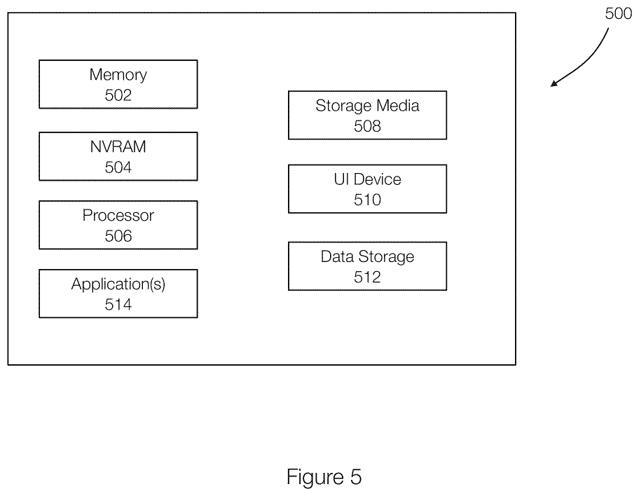

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

The device 500 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The device 500 may also represent a physical or virtual machine or server, an edge-based computing system, a cloud-based computing system, server clusters or other computing systems or environments. The device 500 may also represent multiple machines or devices, whether virtual or physical.

The described embodiments are to be considered in all respects only as illustrative and not restrictive. All changes which come within the meaning and range of equivalency of the claims are to be embraced within their scope.

What is claimed is:

1. A method for training a machine learning model, the method comprising:
determining aggregation metrics for each of a plurality of augmentation functions after performing a current training round of a training operation;
selecting an augmentation function from among the plurality of augmentation functions for a next training round that most impacts a worst performing augmentation function in the training operation; and
performing a next training round using training data from an augmented dataset, wherein the training data is associated with the selected augmentation function.

2. The method of claim 1, wherein determining the aggregation metrics comprises determining an individual aggregation metric for each datum used in the current training round.

3. The method of claim 2, wherein the individual aggregation metric is an aggregation of one or more metrics determined for the current training round.

4. The method of claim 3, wherein the one or more metrics include a validation loss and/or a character error.

5. The method of claim 2, further comprising determining a function aggregation metric for each of the plurality of augmentation functions using the individual aggregation metrics.

6. The method of claim 5, further comprising determining a pseudo gradient for each of the plurality of functions, wherein each of the pseudo gradients reflects an impact of an applied augmentation function on each of the other augmentation functions including the applied aggregation function.

7. The method of claim 6, further comprising generating a synthetic dataset applying one or more augmentation functions to generate an augmented dataset, wherein each augmented datum is tracked according to the applied augmentation function.

8. The method of claim 7, further comprising applying the one or more augmentation functions to each datum in the dataset to generate an augmented dataset, wherein the augmented dataset includes a training dataset and a validation dataset.

9. The method of claim 8, wherein the one or more augmentation functions include a gaussian noise augmentation function, an image rotation augmentation function, and a text generation augmentation function.

10. The method of claim 1, wherein the selected augmentation function comprises a previously unapplied augmentation function.

11. A non-transitory storage medium having stored therein instructions that are executable by one or more hardware processors to perform operations for training a machine learning model, the operations comprising:
determining aggregation metrics for each of a plurality of augmentation functions after performing a current training round of a training operation;
selecting an augmentation function from among the plurality of augmentation functions for a next training round that most impacts a worst performing augmentation function in the training operation; and
performing a next training round using training data from an augmented dataset, wherein the training data is associated with the selected augmentation function.

12. The non-transitory storage medium of claim 11, wherein determining the aggregation metrics comprises determining an individual aggregation metric for each datum used in the current training round.

13. The non-transitory storage medium of claim 12, wherein the individual aggregation metric is an aggregation of one or more metrics determined for the current training round.

14. The non-transitory storage medium of claim 13, wherein the one or more metrics include a validation loss and/or a character error.

15. The non-transitory storage medium of claim 12, further comprising determining a function aggregation metric for each of the plurality of augmentation functions using the individual aggregation metrics.

16. The non-transitory storage medium of claim 15, further comprising determining a pseudo gradient for each of the plurality of functions, wherein each of the pseudo gradients reflects an impact of an applied augmentation function on each of the other augmentation functions including the applied aggregation function.

17. The non-transitory storage medium of claim 16, further comprising generating a synthetic dataset applying one or more augmentation functions to generate an augmented dataset, wherein each augmented datum is tracked according to the applied augmentation function.

18. The non-transitory storage medium of claim 17, further comprising applying the one or more augmentation functions to each datum in the dataset to generate an augmented dataset, wherein the augmented dataset includes a training dataset and a validation dataset.

19. The non-transitory storage medium of claim 18, wherein the one or more augmentation functions include a gaussian noise augmentation function, an image rotation augmentation function, and a text generation augmentation function.

20. The non-transitory storage medium of claim 11, wherein the selected augmentation function comprises a previously unapplied augmentation function.
